(19) United States
(12) Patent Application Publication
(10) Pub. No.: US 2006/0179210 A1
(43) Pub. Date: Aug. 10, 2006

(54) Flash memory data structure, a flash memory manager and a flash memory containing the data structure

(75) Inventor: Nakshatra Saha, Bangalor (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/051,358

(22) Filed: Feb. 4, 2005

(51) Int. Cl. G06F 12/00

(52) U.S. Cl. 711/103

(57) ABSTRACT

A flash memory data structure, a flash memory manager, a flash memory containing the data structure and a method of extending a configuration space of a memory. In one embodiment, the flash memory data structure includes fixed length cells, each having (1) a control and identifier section for containing a unique identifier and (2) a data section for containing a configuration value pertaining to the unique identifier, wherein the unique identifier is dynamically configurable in at least one of the fixed length cells.

### TECHNICAL FIELD OF THE INVENTION

The present invention is directed, in general, to a flash memory and, more specifically, to a data structure for storing configuration data on the flash memory that has dynamic configuration parameters.

### BACKGROUND OF THE INVENTION

Modern computer systems use various types of memory devices including Random Access Memory (RAM) and Read Only Memory (ROM). Computing device often include not only a combination of RAM and ROM but also a hybrid memory device that includes features of both RAM and ROM. An example of a hybrid memory device is an electrically erasable programmable read-only memory (EEPROM), now more commonly known as “flash” memory.

Flash memory is a non-volatile data storage medium typically used to store codes. Vendors, for example, use flash memory to store such sections as files, images, bootloader and device/software configuration information. Flash memory combines the best features of memory devices to provide a high density memory that is electrically re-programmable. Accordingly, flash memory is being used more often in computing devices and has become especially popular among embedded devices, such as modems, IP phones, switches, routers, handhelds, etc.

Flash memory includes a number of memory blocks that can vary in size depending on the manufacturer. The memory blocks are sections of an array of memory cells in the flash memory. Some manufacturers provide memory blocks in the flash memory, often referred to as tiny blocks, to be used for configuration space. Each memory block used for configuration space, (i.e., a tiny block) stores configuration data that may be identified by data names stored as data strings. Alternatively, as disclosed in related U.S. patent application Ser. No. 10/774,302, by inventor Nakshatra Saha entitled “A FLASH MEMORY DATA STRUCTURE AND METHODS OF ACCESSING THEREOF,” filed Feb. 6, 2004, and which is incorporated herein by reference in its entirety, a unique identifier may be employed instead of a configuration data string name.

The unique identifier is a unique number used to represent each configuration parameter of a memory system associated with the flash memory. Thus, instead of requiring multiple bytes to store a configuration parameter name string with the configuration value, the unique identifier is stored in a control and identifier section of the flash memory data structure for each configuration data. Accordingly, the data section only stores the associated configuration value, which prevents wastage of flash configuration space.

The unique identifiers, however, are determined during manufacturing and are not configurable after release. Flexibility, therefore, of the configuration space for flash memory is limited after release. Thus, existing flash memory does not provide support for the runtime addition of new configuration parameters.

Additionally, typical programming of flash memory requires manual allocation of space for each section stored thereon. Manual allocation includes setting an address and size for each of the sections stored on the flash memory. Thus, manual allocation typically requires an engineer that understands the properties of a particular flash memory being used, such as, the number of blocks, the size of each block and the location of tiny blocks. When the sections on the flash memory change, (i.e., new sections added, existing sections deleted, change in section size, etc.), the engineer must manually design usage of the flash memory space, optimize the usage and configure the flash memory. The changes are then hard-coded in software and often spanning across multiple files requiring substantial manual effort for each configuration.

Furthermore, once a device employing flash memory is designed, if a new section is needed in the flash memory, the process of designing the flash memory is repeated including modification of the source code. When a device includes multiple types of flash memory (i.e., different vendors having different characteristics), the manual effort and the supporting software logic can become extensive and complicated in addition to manual configuring each flash memory.

Accordingly, what is needed in the art is a flexible flash memory that can be controlled during development and post release.

### SUMMARY OF THE INVENTION

To address the above-discussed deficiencies of the prior art, the present invention provides a flash memory data structure, a flash memory manager and a flash memory containing the data structure. In one embodiment, the flash memory data structure includes fixed length cells, each having (1) a control and identifier section for containing a unique identifier and (2) a data section for containing a configuration value pertaining to the unique identifier, wherein the unique identifier is dynamically configurable in at least one of the fixed length cells.

The flash memory data structure of the present invention advantageously employs unique identifiers that can be dynamically configurable. Thus, the present invention provides a flexible flash memory having configuration parameters that can be changed during development and after release. Accordingly, the flash memory data structure can be changed by after-market upgrades.

In another embodiment, the present invention provides a flash memory including: (1) a bootloader and (2) a data structure with fixed length cells, having (2a) a control and identifier section for containing a unique identifier and (2b) a data section for containing a configuration value pertaining to the unique identifier.

The novel flash memory manager of the present invention can be used for configuration (including reconfiguration when needed) of the flash memory. For configuration, the flash memory manager needs the sections that are required to be positioned on the flash memory and a minimum size needed to allocate for each section. The flash memory manager may employ a programming macro, such as, an application programming interface (API), to configure the flash memory.

In yet another aspect, the present invention provides a method of extending a configuration space of a memory, including (1) designating a unique identifier to represent an information-installation configuration parameter, (2) storing information pertaining to an extended configuration space, and (3) installing the extended configuration space in the memory based on the information.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a memory system constructed according to the principles of the present invention; and

FIG. 2 illustrates a block diagram of an embodiment of a flash memory data structure constructed according to the principles of the present invention.

### DETAILED DESCRIPTION

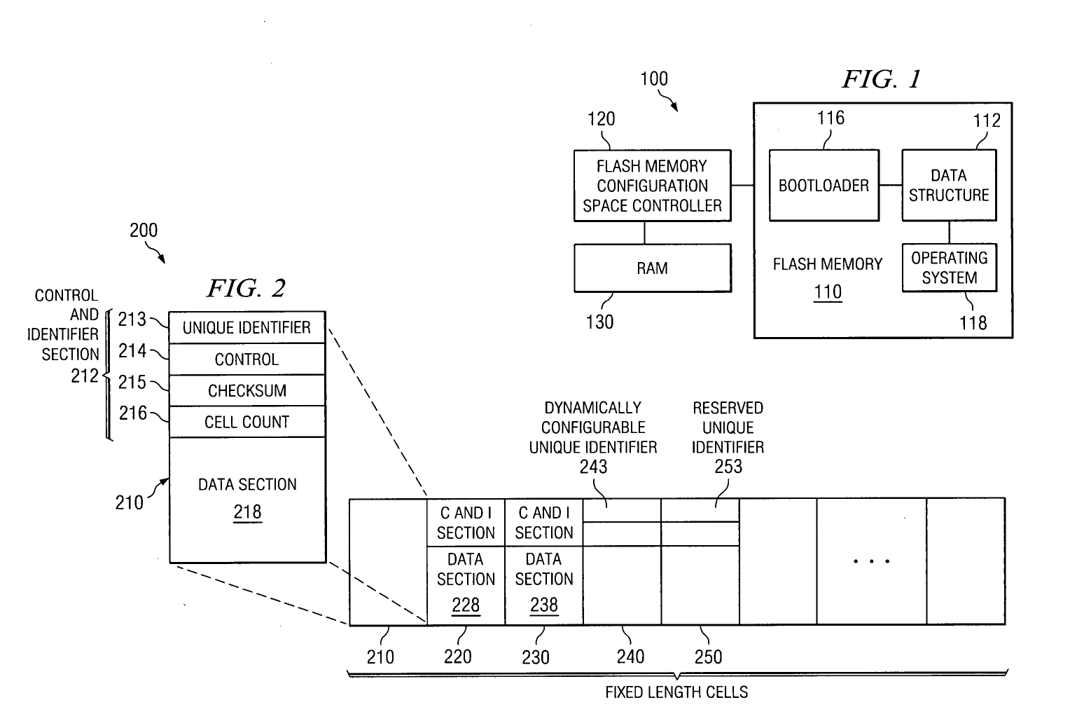

Referring initially to FIG. 1, illustrated is an embodiment of a block diagram of a memory system, generally designated 100, constructed according to the principles of the present invention. The memory system 100 includes a flash memory 110, a flash memory manager 120 and a random access memory (RAM) 130. The flash memory 110 includes a data structure 112, a boot loader 116 and an operating system 118.

The memory system 100 is typically employed in embedded devices including modems, Voice-over-Internet Protocol (VoIP) phones, routers, switches and various handheld devices such as personal digital assistant (PDAS). In addition to the components illustrated and discussed, one skilled in the art will understand that the memory system 100 may include additional components commonly employed within memory systems of the above devices.

The data structure 112 is an array of memory cells. At least a portion of the data structure 112 is used for configuration space of the flash memory 110. Typically, configuration space is used to hold an integral number of configuration data including configuration parameters and associated configuration values. System designers may employ configuration space to store various system and application specific configuration parameters and corresponding configuration values as the overall system configuration data. Typical configuration parameters include various system properties, (i.e., CPU frequency, system bus frequency, etc), networking parameters, (i.e., interface IP addresses, MAC addresses, subnet-masks, etc), various operation boot commands and application specific parameters (i.e., re-transmission counts, timeouts, etc.). The configuration parameters can vary from system to system based on use and requirements.

Some of the memory cells of the data structure 112 are configured into a tiny block of fixed length cells and designated configuration space. Advantageously, configuration space of the data structure 112 is modular and customizable. A size of the configuration space may be modified employing a programming macro embodied, for example, within the flash memory manager 120. Typically, the programming macro considers the number of fixed length cells that are required to store the configuration data. The configuration space may be sized to about two or three times the required configuration data based on a manufacturing stage of development. For example, a product in a validation phase will typically require more configuration space than a product ready for release. The size of the configuration space therefore can be modified based on the manufacturing stage and the required configuration values.

Each of the fixed length cells includes a control and identifier section and a data section. The control and identifier section contains a unique identifier and a cell count that can logically associate multiple of the fixed length cells. The data section contains only a configuration value pertaining to the unique identifier. Each of the fixed length cells may equal a minimum storage space for the configuration value.

The cell count enables the configuration value to have a size that is not constrained by a size of the fixed length cells. The cell count stores the number of fixed length cells that includes the configuration value pertaining to each of the unique identifiers. Thus, the fixed length cells having a size less than the configuration value can be logically associated, or concatenated, to further reduce wastage of memory space.

A new configuration space (configuration space not originally configured) may be installed on the flash memory 110 as required by a software component. Information, such as, base address and size, pertaining to the new configuration space may be updated in the original configuration space using a configuration parameter. This information is concatenated in a pre-defined fashion, differentiated using delimiters and stored as a configuration parameter value. This installation-information configuration parameter is pre-defined for any software component to identify it before using it. The configuration parameters and associated values through the unique identifiers may be accessed in the flash memory 110 employing the boot loader 116 or the operating system 118. In some embodiments, other applications/images residing on the memory system 100 may also require access to the configuration parameters.

Though the flash memory 110 is used to discuss new configuration space, one skilled in the art will understand that new configuration space can be installed on a variety of memory types, such as, RAM or ROM, based on the availability of free memory space. This provides support for system-wide scattered configuration space installation and adds flexibility for any future system requirements.

In addition to adding new configuration space, configuration parameters and configuration parameter values may be employed to install an other configuration space (third) utilizing free memory space. Accordingly, the information related to the third configuration space installation can be updated to the new (second) configuration space using pre-defined installation-information configuration parameters. Hence, this activity has the potential to be repeated multiple times and linked like a chain.

The configuration parameters and configuration parameter values allow flexibility such that separate configuration space handlers (or software components associated with the configuration space) may be associated with each of the installations. If so, respective function pointers are updated in a function pointer table and the pointer to the table is added to the installation-information configuration parameter value holding information for the particular installation (i.e., in the previous installation). This addition is again performed in a pre-defined format and differentiated from the others using delimiters. Hence, multiple information fields can be added to the installation-information configuration parameter value, based on necessity.

The present invention also supports multiple instances of a given configuration parameter existing in various installations. In this scenario, a system wide protocol is maintained that takes precedence over other protocols. Maintaining a system wide protocol may depend on system requirements for support.

The flash memory manager 120, coupled to the flash memory 110, is configured to impose the data structure 112 on the flash memory 110. The flash memory manager 120 understands the flash memory 110 (i.e., the vendor and specific characteristic based on the vendor) and intelligently allocates the flash memory 110. The flash memory manager 120 may employ a sequence of executable software instructions, dedicated hardware or a combination thereof to impose the data structure. As mentioned above, the flash memory manager 120 may employ a programming macro. The flash memory manager 120 may include components commonly employed within a conventional configuration controller associated with flash memory.

The flash memory manager 120 may employ the programming macro to place an appropriate number of the fixed length cells into tiny blocks based on the needed configuration space. This may be done prior to release or, advantageously, after release. Thus, the programming macro of the flash memory manager 120 provides a mechanism for the data structure 112 to be configured at an early stage of the product and customization when needed due to a change in the configuration space requirements.

The programming macro may automatically select the appropriate block sizes to use for configuration space. For example, the best size of a tiny block may be automatically selected during the product phase of a vendor based on configuration space requirements. Thus, the flash memory 110 does not require manual intervention to select the best size of a tiny block to use for configuration space. Additionally, due to a limited number of tiny blocks, the programming macro can optimize use of the flash memory 110 by allocating sections that require tiny blocks first.

The programming macro may be priority based to facilitate that demanding applications get a fair portion of the data structure 112. In addition to configuration space, the flash memory manager 120 may employ the programming macro to configure the data structure 112 for other memory space needed by associated applications. Hence the present invention provides a modular and customizable method of configuring the data structure 112 for configuration space and other required memory needs.

The flash memory manager 120 may also employ the programming macro to fragment a tiny block that is designated for configuration space for other sections that may be needed. This proves useful in products having a flash memory size that is small and the designated configuration space of the data structure 112 is greater than the required configuration space. Fragmenting designated blocks is not limited to designated to tiny blocks or configuration space blocks in the data structure 112. The flash memory manager 120 is also configured to support fragmentation of other blocks in the flash memory 110 to position multiple sections in the same block. This is especially advantageous in low-cost products with minimum flash memory space. When fragmenting blocks, the programming macro is called with the needed size of space.

If fragmenting a block across sections (i.e., positioning multiple sections in a given block) is not required and obtaining a tiniest block available is desired for a section, the programming macro can be employed to allocate space with a size requirement of 1 byte. Thus, the flash memory manager 120 knows that minimum space is required and can allocate the tiniest block available.

The programming macro can improve configuring of the flash memory 110 by only requiring information pertaining to what section or sections are required to be positioned on the flash memory 110 and the minimum size to be allocated for each section. Accordingly, the allocation required for the flash memory 110 can be performed by calling the programming macro with the required minimum size. Multiple such calls to the programming macro can be made for multiple sections on the flash memory 110.

The RAM 130, coupled to the flash memory manager 120, is configured to temporarily store the configuration values before being written to the flash memory 110. This can be used as a scratch pad to work on the configuration data before writing to the flash data structure.

Turning now to FIG. 2, illustrated is an embodiment of a block diagram of a flash memory data structure, generally designated 200, constructed according to the principles of the present invention. The flash memory data structure 200 represents at least a portion of a memory array of a flash memory. For example, the flash memory data structure 200 may be employed in a memory system such as illustrated in FIG. 1.

The flash memory data structure 200 includes multiple fixed length cells that have been configured into a block (i.e., a tiny block) for configuration space. Advantageously, at least some of the fixed length cells are automatically configured into a block for the configuration space based on configuration requirements. In some embodiments, the fixed length cells may be configured into a block for configuration space and then only a fragment of the block is used for the configuration space. A controller, such as the flash memory manager 120 of FIG. 1, may be employed to configure the data structure 200. Fixed length cells 210, 220, 230, 240 and 250 have been specifically designated to allow a detailed discussion of the flash memory data structure 200.

The fixed length cell 210 includes a control and identifier section 212 having fields for a unique identifier 213, a control 214, a checksum 215 and a cell count 216. Additionally, the fixed length cell 210 includes a data section 218 for containing only a configuration value pertaining to the unique identifier 213 (and not a configuration parameter name string). In some embodiments, a portion of the control and identifier section 212 may be configured to contain at least a portion of the configuration value. This provides added flexibility to the data structure 200.

The fixed length cell 210 is 32 bytes long, the control and identifier section 212 is 4 bytes long and the data section 218 is 28 bytes long. The fixed length cell 210 is sized at 32 bytes since this is sufficiently large enough to store a majority of the configuration values. Sizing the fixed length cell 210 at 32 bytes can also be helpful while using some of the advanced write mechanisms provided by various flash vendors to allow faster write access. This mechanism supports improved system performance and often parallel programming, given lower power consumption. Thus, the fixed length cell 210 sized at 32 bytes can reduce storage space wastage since a minimum amount of storage space wasted is less than 32 bytes and can advantageously operate with existing flash devices to allow fast write access.

Additionally, having the control and identifier section 212 sized at four bytes long, minimizes a read of the data structure 200 which expedites look-ups of configuration values. For example, on a 32-bit flash data bus, a read is about one cycle long and on a 16-bit flash data bus, a read is about two cycles long for a four byte sized control and identifier section 212. Thus, in a one or two read cycle delay, a single read can provide sufficient information to support a lookup related to a given fixed length cell. With the minimum delay, the unique identifier 213 of the fixed length cell 210 can be known and if a lookup is meant for the configuration value stored in the data section 218. If not, the cell count 216 informs how many fixed length cells to skip to reach the next configuration value. In some embodiments, the lookup delay for 16-bit flash devices can be reduced to one cycle by positioning the unique identifier and count fields in two subsequent bytes at the beginning of the control and identifier section 212. If the unique identifier 213 indicates a hit, the control 214 indicates whether the configuration value is marked as deleted. If not deleted, the checksum 215 indicates if the configuration value is valid. To speed up processing, the above decisions can be done in a register level of a processor coupled to the data structure 200.

Of course, the size of the fixed length cell 210 may vary in different embodiments. In some embodiments, the fixed length is determined based on optimizing storage space of the data structure 200. Having adequately sized fixed length cells for a majority of the configuration data and using unique identifiers effectively reduces the configuration space. Additionally, having smaller sized fixed length cells allow the accommodation of more fixed length cells within the configuration space that decreases the frequency of erasing flash memory configuration space when it is full. On systems where configuration values can be much smaller, the size of the fixed length cell 210 can also be decreased, for example, to 16 bytes. This can be supported by decreasing the data section 218 from, for example, 28 to 12 bytes using programming macros.

The unique identifier 213 is a one byte long number given to uniquely identify each configuration parameter instead of storing configuration parameter name strings. Hence, the data structure 200 may cooperate with a lookup table to provide a one-to-one correspondence between each of a memory system's configuration parameter and a unique identifier, such as, the unique identifier 213. The unique identifier 213 is pre-defined. In other words, the unique identifier 213 has been assigned to a configuration parameter before the release phase.

Employing the unique identifier 213 is advantageous for embedded systems that have pre-defined configuration parameters which are added, updated and retrieved in runtime. The usage of configuration parameter name strings is usually only meaningful for user based systems requiring support for various types of users at runtime or for memory systems that support execution of downloadable applications that add at runtime new configuration parameters based on requirements.

Having the size of unique identifier 213 equal to one byte restricts the possible configuration parameters to 254. Of the possible 256 values that can be held in a 1 byte long variable, zero is left as reserved and the value of 255 is not used since that is the default value of flash memory when it is not written to after erase. A maximum amount of 254 configuration parameters is sufficient for most memory systems. However, the number of configuration parameters can be increased beyond 254.

The control 214 and the checksum 215 are each set at a length of one byte. The control 214 contains management information for the configuration value. A marker employing a single bit of the control 214 is used to denote whether the configuration value is valid or deleted. If deleted, the marker indicates the configuration value is garbage. The other remaining bits are designated as reserve. The checksum 215 is the checksum value of the configuration value stored in the associated data section 218. The checksum 215 may be employed to validate the integrity of the configuration value.

The cell count 216 is one byte long and represents the number of contiguous fixed length cells employed to store the configuration data. With the size of the cell count 216 being one byte, a maximum size of configuration data may be 255 times the size of a fixed length cell. When the size of configuration value of a configuration parameter is more than the size of one fixed length cell's data section, subsequent fixed length cells are used, based on the size of the configuration value, to store the configuration data. Under such a scenario, the control and identifier section of only the first fixed length cell is used and the following fixed length cells are concatenated to the first cell's data section. For example, the cell count 216 may indicate that the configuration value, too large to store in just data section 218, is also stored in data sections 228 and 238 of the contiguous fixed length cells 220 and 230. The size of the fixed length cell 210, therefore, may be smaller than the configuration value to keep the storage space wastage to a minimum.

Thus, each of the fields in the control and identifier section 212 are one byte long. This may vary in other embodiments. For example, the size of the unique identifier 213 may be increased by using most of the control 214 since only a single bit is being used. Additionally, the arrangement of the fixed length cell 210 may vary in different embodiments. Typically, the control and identifier section 212 is located at the beginning of the fixed length cells as illustrated in FIG. 2. In some embodiments, however, the data section 218 is located at a beginning of the fixed length cells and the control and identifier section 212 is located at the end. This will allow a backward search that can increase the speed of searching the data structure 200.

For example considering FIG. 2, every new configuration data is added starting at the address of the first free fixed length cell. After adding new data, the first free fixed length cell address is updated to point to the start of the next immediate free fixed length cell. When a configuration data is updated/modified, the earlier instance of the configuration data, which is located anywhere at a lower address, is marked deleted. Searching of the data structure 200 starts from the base of the configuration space, reading the control and identifier section 212 of each of the fixed length cells holding each configuration data while moving upwards, until the valid, not marked deleted, instance of the desired configuration data is located. In other words, several fixed length cells are typically “hopped-over,” skipping possibly many deleted instances to hit the current valid configuration data.

Hence the valid configuration data is positioned close to the end and the deleted ones are close to the base of the data structure 200. Thus, a faster lookup can be achieved by searching from the end of the data structure 200, or searching from the address of the first free fixed length cell moving downwards. This will provide a faster search compared to conventional flash memory search methods.

As discussed above, the unique identifier 213 is pre-defined. The data structure 200, however, is not restricted to only pre-defined unique identifiers. A bit in the control and identifier section may be used to mark a dynamic environment variable. During updating of the dynamic environment variable, the bit is enabled. During searching of the flash memory data structure 200, the bit is checked to distinguish between a dynamically configurable variable and a pre-defined variable.

The dynamically configurable unique identifier 243 is an example of such a dynamic environment variable. As illustrated by dynamically configurable unique identifier 243, the data structure 200 may include a combination of pre-defined and dynamically configurable unique identifiers. The dynamically configurable unique identifier 243: can be used during a manufacturing development phase of a product or after release of the product.

In some embodiments, the data structure 200 may be associated with a product and the unique identifier 243 is provided to the data structure 200 after the release of the product. Thus, the data structure 200 supports the runtime addition of new unique identifiers and corresponding configuration parameters. Additionally, vendors can update configuration data and unique identifiers throughout the development phase until the release phase. Thus, developers are given flexibility in defining and using variable. The data structure 200 also provides support for vendors who have products that support execution of downloaded applications as well as a multi-user system. Furthermore, with update capability, the data structure 200 supports virtually an ‘infinite’ sized configuration parameter value. Thus, the data structure 200 provides the capability of pre-defined and dynamically configurable configuration data (including unique identifiers) that may be employed in open or closed systems.

The data structure 200 may also include a unique identifier that is reserved during production for dynamic configuration thereafter. Reserved unique identifier 253 is “set aside” during production to be employed at a later date. This allows the reserved unique identifier 253 to be assigned by a user after release.

As demonstrated above, the present invention allows the simultaneous existence of both static and dynamic configuration variables for flash memory that supports both development and release platforms for configuration space handlers. Additionally, the present invention allows for runtime addition of new configuration parameters and for having a virtually infinite name space for configuration parameters. Also, the present invention provides a data structure of flash memory that may be automatically segmented (and sub-segmented) based on priority requirements, as opposed to prior support of manual configuration. Furthermore, the data structure may employ a reserved value of a unique identifier to extend it for the addition of new features.

The present invention provides a novel flash memory data structure, flash memory manager and a flash memory. Additionally, the present invention provides a method of extending a configuration space of a memory. Though a single flash memory manager and flash memory was illustrated, one skilled in the art will understand that the novel flash memory manager will support multiple flash memory devices in a memory system. The flash memory manager can provide a single list of programming macros for the memory system that can be employed to internally handle various flash memories and hide the complexity of multiple flash memories from the memory system.

One skilled in the art will also understand that memory systems may include multiple software cores, such as, bootloader, OS image, etc. and that the flash memory manager may be implemented in one, some or all of these cores. This can improve the exchange of information about allocated sections on the flash memory or memories.

Although the present invention has been described in detail, those skilled in the art should understand that they can make various changes, substitutions and alterations herein without departing from the spirit and scope of the invention in its broadest form. For example, the present invention also applies to memories that employ configuration data name strings.

What is claimed is:

1. A flash memory data structure, comprising:
fixed length cells, having:
a control and identifier section for containing a unique identifier, and
a data section for containing a configuration value pertaining to said unique identifier, said unique identifier dynamically configurable in at least one of said fixed length cells.

2. The data structure as recited in claim 1 wherein at least a portion of said fixed length cells are automatically configured into a block based on configuration requirements.

3. The data structure as recited in claim 1 wherein said fixed length cells are configured into a block for configuration space and only a fragment of said block is used for said configuration space.

4. The data structure as recited in claim 1 wherein said configuration value is employed to extend original configuration space.

5. The data structure as recited in claim 1 wherein said unique identifier in at least an other of said fixed length cells is pre-defined.

6. The data structure as recited in claim 1 wherein a portion of said control and identifier section is configured to contain at least a portion of said configuration value.

7. The data structure as recited in claim 1 wherein said unique identifier is employed to extend original configuration space.

8. A flash memory manager for imposing on a flash memory the data structure as recited in claim 1.

9. A flash memory manager for imposing on a flash memory the data structure as recited in claim 2.

10. A flash memory manager for imposing on a flash memory the data structure as recited in claim 3.

11. A flash memory manager for imposing on a flash memory the data structure as recited in claim 4.

12. A flash memory manager for imposing on a flash memory the data structure as recited in claim 5.

13. A flash memory manager for imposing on a flash memory the data structure as recited in claim 6.

14. A flash memory manager for imposing on a flash memory the data structure as recited in claim 7.

15. A flash memory, comprising:
a bootloader; and
a data structure, coupled to the bootloader, including fixed length cells, having:
a control and identifier section for containing a unique identifier, and
a data section for containing a configuration value pertaining to said unique identifier.

16. The flash memory as recited in claim 15 wherein at least a portion of said fixed length cells are automatically configured into a block based on configuration requirements.

17. The flash memory as recited in claim 15 wherein said fixed length cells are configured into a block for configuration space and only a fragment of said block is used for said configuration space.

18. The flash memory as recited in claim 15 wherein said configuration value is employed to extend original configuration space

19. The flash memory as recited in claim 15 wherein said unique identifier is pre-defined.

20. The flash memory as recited in claim 15 wherein a portion of said control and identifier section is configured to contain at least a portion of said configuration value.

21. The flash memory as recited in claim 15 wherein said unique identifier is employed to extend original configuration space.

22. A method of extending a configuration space of a memory, comprising:
designating a unique identifier to represent an information-installation configuration parameter;
storing information pertaining to an extended configuration space;
installing said extended configuration space in said memory based on said information.

23. The method as recited in claim 22 wherein said configuration space is physically unaltered.

24. The method as recited in claim 22 wherein said unique identifier is pre-defined.

25. The method as recited in claim 22 wherein said information is stored as an information-installation configuration value and said information-installation configuration value is updated based on new configuration requirements.

26. The method as recited in claim 22 further comprising repeating each step of claim 22 to add multiple extended configuration spaces.

27. The method as recited in claim 22 further comprising chaining said multiple extended configuration spaces together with said extended configuration space.

28. The method as recited in claim 22 further comprising a macro to extend said configuration space.
